(19) United States
(12) Patent Application Publication
(10) Pub. No.: US 2026/0233378 A1
(43) Pub. Date: Aug. 13, 2026

(54) MODULAR STORAGE BOX WITH SMOOTH RAIL SYSTEM

(71) Applicant: Great Neck Saw Manufacturers, Inc., Memphis, TN (US)

(72) Inventor: Jeffrey G. Karl, Rossville, TN (US)

(73) Assignee: Great Neck Saw Manufacturers, Inc., Memphis, TN (US)

(21) Appl. No.: 19/532,603

(22) Filed: Feb. 6, 2026

Related U.S. Application Data
(60) Provisional application No. 63/755,394, filed on Feb. 7, 2025.

(51) Int. Cl. B25H 3/02; B65D 21/02; B65D 25/22

(52) U.S. Cl. CPC B25H 3/022; B65D 21/0222; B65D 25/22

(57) ABSTRACT

A modular storage box can include a base and an intermediate portion having a first end and a second end. The base can be coupled to the intermediate portion at the first end. The intermediate portion can include a plurality of faces. The modular storage box can include a lid coupled to the intermediate portion at the second end. The lid can enclose an interior volume of the modular storage box. A mounting system may be defined at the lid. The mounting system can include a cleat structure defining a pocket extending longitudinally along a first portion of the lid with an opening oriented in a first orientation and an engagement structure comprising a groove extending longitudinally along a second portion of the lid opposite the pocket.

### CROSS-REFERENCE TO RELATED APPLICATIONS

This application claims the benefit of and priority to U.S. Application No. 63/755,394, filed Feb. 7, 2025, titled MODULAR STORAGE BOX WITH SMOOTH RAIL SYSTEM, the entire disclosure of which is hereby incorporate by reference in its entireties and for all purposes.

### BACKGROUND

Hand tools, such as hammers or ratchets, power tools, such as drills or circular saws, and accessories such as bits, batteries, or fasteners, may frequently be moved between a storage location and a workspace. It is desirable to transport and access such tools and accessories in a quick and efficient manner using storage boxes. Such storage boxes may be loaded with appropriate tools and accessories and transported to a workspace for use. Due to inherent size and space constraints, and in cases where many tools and accessories are needed, multiple storage boxes may be used and stacked and/or connected together for ease in transportation. Despite progress made in the field of storage boxes and related storage systems, there is a need in the art for improved connection mechanisms for storage boxes that maintain sufficient latching strength without an undesirable reduction in the interior volume of the storage boxes and/or limitations dues to predefined and fixed mounting locations.

### SUMMARY

Aspects of the present disclosure describe modular storage assemblies having smooth rail systems. In one example, a modular storage box is provided. The modular storage box comprises: a base; an intermediate portion having a first end and a second end, wherein the base is coupled to the intermediate portion at the first end, and wherein the intermediate portion comprises a plurality of faces; a lid coupled to the intermediate portion at the second end, wherein the lid encloses an interior volume of the modular storage box; and a mounting system defined at the lid, the mounting system comprising: a cleat structure defining a pocket extending longitudinally along a first portion of the lid with an opening oriented in a first orientation; and an engagement structure comprising a groove extending longitudinally along a second portion of the lid opposite the pocket.

In some examples, the cleat structure is releasably couplable with a corresponding cleat structure positioned on a second base of a second modular storage box. In some examples, the cleat structure comprises a base portion including a base leading end defining a cleat insertion surface. In some examples, the pocket is formed in a space between the cleat insertion surface and a surface of the lid. In some examples, the cleat insertion surface is substantially parallel to the lid. In some examples, the latch structure comprises a biasing element configured to apply a horizontal force in a direction of the first orientation when the latch structure is received by the corresponding groove of a second modular storage box. In some examples, the biasing element comprises a spring.

In some examples, the base comprises at least one cleat insertion structure having a base portion and a base leading end, wherein the base leading end is configured to be inserted into a pocket of a second modular box to latch the modular storage box to the second modular storage box.

In some examples, a modular storage box is provided. The modular storage box includes a base; an intermediate portion having a first end and a second end, wherein the base is coupled to the intermediate portion at the first end, and wherein the intermediate portion comprises a plurality of faces; a lid coupled to the intermediate portion at the second end, wherein the lid encloses an interior volume of the modular storage box; and a rail system defined on at least one face of the plurality of faces, the rail system comprising: a plurality of rail insertion structures protruding outwards from the at least one face, wherein each rail insertion structure includes a respective base and a respective leading end thereby forming a respective rail insertion surface.

In some examples, each rail insertion structure is oriented in a direction extending towards the base. In some examples, the at least one face comprises a first upper region and a first lower region, wherein a first subset of the plurality of rail insertion structures are positioned in the first upper region and a second subset of the plurality of rail insertion structures are positioned in the first lower region. In some examples, the first subset of the plurality of rail insertion structures and the second subset of the plurality of rail insertion structures are discontinuous along the at least one face. In some examples, the first subset of the plurality of rail insertion structures are staggered with respect to the second subset of the plurality of rail insertion structures thereby defining a staggered pattern on the at least on face. In some examples, the plurality of rail insertion structures are configured to releasably couple with corresponding rail receiving structures outwardly protruding from a mounting plate secured to a wall. In some examples, the rail receiving structures are oriented in a direction opposite the second orientation. In some examples, the plurality of faces comprises a first side face including a first handle and a second side face including a second handle and the first handle and the second handle each include a through hole.

In some examples, a storage system is provided. The storage system includes a first modular storage box comprising: a base; an intermediate portion having a first end and a second end, wherein the base is coupled to the intermediate portion at the first end, and wherein the intermediate portion comprises a plurality of faces; a lid coupled to the intermediate portion at the second end, wherein the lid encloses an interior volume of the first modular storage box; and a first mounting system defined at the base, the first mounting system comprising a first base leading end orthogonally extending from a cleat insertion surface, wherein the first base leading end is parallel to the base; a second modular storage box comprising: a lid having a second mounting system, wherein the second mounting system comprises: a cleat structure defining a pocket extending longitudinally along a first portion of the lid with an opening oriented in a first orientation; and an engagement structure comprising a groove extending longitudinally along a second portion of the lid opposite the pocket, wherein the second mounting system is configured to receive the first base leading end of the first mounting system in the pocket to releasably couple the first modular storage box to the second modular storage box thereby defining a combined modular storage box.

In some examples, the storage system includes a hand truck, comprising: a frame having a first frame end including a handle and a second frame end including one or more removable wheels; and a base plate coupled to the frame at the second frame end and having a rail receiving system configured to releasably couple with a rail insertion system of one of the first modular storage box or the second modular storage box.

### BRIEF DESCRIPTION OF THE DRAWINGS

FIG. 1 is a perspective view of a modular storage system that includes a smooth rail system according to some aspects of the present disclosure.

FIG. 2A is a perspective view of a modular storage box that includes a smooth rail system according to some aspects of the present disclosure.

FIG. 2B is an enlarged view of a portion of the smooth rail system of FIG. 2A according to some aspects of the present disclosure.

FIG. 3A is a perspective view of a lid for a modular storage box according to some aspects of the present disclosure.

FIG. 3B is a cross-sectional view of the lid of FIG. 3A according to some aspects of the present disclosure.

FIG. 4A is a bottom view of a base portion of a modular storage box according to some aspects of the present disclosure.

FIG. 4B is a side view of an intermediate portion of a modular storage box according to some aspects of the present disclosure.

FIG. 5A is a cross-sectional view of a modular storage box according to some aspects of the present disclosure.

FIG. 5B is an enlarged view of a cleat structure of the modular storage box of FIG. 5A according to some aspects of the present disclosure.

FIG. 6 is a perspective view of a hand truck with a mounting plate according to some aspects of the present disclosure.

FIG. 7A is perspective view of the mounting plate of FIG. 6 according to some aspects of the present disclosure.

FIG. 7B-1 is a side view of the mounting plate of FIG. 7A according to some aspects of the present disclosure.

FIG. 7B-2 is an enlarged view of a portion of the mounting plate of FIGS. 7A-7B according to some aspects of the present disclosure.

### DETAILED DESCRIPTION

Hand tools, such as hammers or ratchets, power tools, such as drills or circular saws, and accessories such as bits, batteries, or fasteners, may frequently be moved between a storage location and a workspace. Storage boxes, modular storage boxes, cases, storage systems, etc. (hereinafter “storage boxes” or “modular storage boxes”) may enable such transportation. Conventional modular storage boxes are typically designed with compartments or dividers to help keep tools separated and accessible and may be stacked and/or connected to other modular storage boxes using a “pocket” design (e.g., recesses form in the lid connectable with protrusions form in the base of another modular storage box), external locking mechanisms, straps (e.g., ratchet straps, cable locks, etc.), and so on.

Due to inherent size and space constraints associated with such storage boxes, conventional modular storage boxes, in particular those with pocket designs, have significant drawbacks. One common issue is their limited internal space, which can make it difficult to store larger tools or multiple items efficiently (e.g., due to the deep latching pockets protruding inwards into the interior volume of the modular storage box). Additionally, many conventional modular storage boxes lack effective and/or flexible stacking and/or latching mechanisms thereby leading to instability or wasted vertical space when multiple storage boxes are used together and/or leading to an inability to couple and/or decouple the storage boxes to other storage boxes or to other accessories such as hand trucks and/or wall mounts. Such rigid designs used in conventional modular storage boxes lead to challenges in customizable storage configurations reducing the overall versatility for diverse tool collections and/or a variety of uses.

Examples described herein relate to a modular storage box having a smooth rail mounting system configured to selectively couple and decouple with other storage boxes in a modular storage system, such as a tool storage unit. In more detail, the smooth rail mounting system enables the modular storage box to be stacked and/or latched together with other modular storage boxes of similar type in a variety of different orientations (e.g., horizontal latching, vertical stacking, wall mounting, integration with a hand truck, etc.). For example, one modular storage box may be stacked on top of another modular storage box where the two modular storage boxes are secured together using a smooth rail mounting system. As another example, two half sized modular storage boxes may latch into a full-sized modular storage box (e.g., the base portions of the half-sized modular storage boxes may latch into the lid of the full sized modular storage box) via a smooth rail mounting system integrated into the respective base and lids portions t. Further, another full-sized modular storage box may then latch into the respective lid portions of the two half sized modular storage boxes. Such quick and efficient stacking via the smooth rail mounting system enables a modular storage system of multiple modular storage boxes to be stacked and connected together.

The smooth rail mounting system includes various components defined at the various faces of the respective modular storage box. The smooth rail mounting system enables quick and secure coupling and/or decoupling between multiple storage boxes in of varying sizes in a modular storage system without undesirably reducing the interior volume of any one particular modular storage box in the system. Additionally, the smooth rail mounting system also provides a high degree of configurability and flexibility as the integrated smooth rail mounting system is configured to interface with wall mounting systems and/or hand truck mounting systems, which may similarly include respective receiving portions configured to couple and/or decouple with the smooth rail mounting system of the storage boxes. In one example, the smooth rail mounting system may including a mounting system defined at the lid and the base of a modular storage box. The smooth rail mounting system may also include a rail insertion system defined on one or more sidewalls of the modular storage box. The mounting system of the lid and the base may include respective cleat structures and/or grooves to enable latching. For instance, a second modular storage box with a similar mounting system may have protruding cleat structures on the base that can latch into the mounting system of the lid. The rail insertion system may include protruding rail insertion structures (e.g., hooks) configured to releasably couple with additional accessories such as a hand truck, wall mounting plate, etc., as described in more detail below.

In some examples, the cleat structures and corresponding pockets or grooves may be implemented using a variety of alternative mechanical geometries beyond cleats and beyond French cleats. For instance, the cleat structure may comprise a dovetail profile, where the cleat and receiving pocket each have complementary angled or trapezoidal surfaces that interlock to resist separation in one or more directions. In such examples, the pocket defined at the lid may have a dovetail shape that receives a correspondingly shaped dovetail projection on the base or sidewall of another modular storage box. Alternatively, the cleat and pocket may form a tongue-and-groove connection, a T-slot, a stepped or ledged interface, or other interlocking shapes that provide secure, releasable engagement between modular storage boxes. The cleat and pocket may also be formed with arcuate, rectangular, or polygonal cross-sections, as appropriate for the desired strength and ease of coupling or decoupling.

In some examples, the smooth rail mounting system may be implemented as a French cleat rail system. Depending on the particular surface of the modular storage box (e.g., the lid portion, base portion, sidewalls, back portion, or front portion), respective insertions portions and/or respective receiving portions of the French cleat rail system may be included. For instance, a base portion of a first modular storage box may include an insertion portion of the smooth rail mounting system. Such insertion portions may be configured to be received by respective receiving portions of the smooth rail mounting system integrated into a lid of a second modular storage box during coupling and/or decoupling. In more detail, and as described below with respect to the figures, the respective receiving portions of the smooth rail mounting system may form a space (e.g., pocket) into which the respective insertion portions may be inserted. As such, the first modular storage box may slide into and connect with the second modular storage box via the insertion portion of the first modular storage box being received by the receiving portion of the second modular storage box.

The smooth rail mounting system may include additional connection elements to further strengthen the connections between multiple modular storage boxes. For instance, a latch structure may be incorporated into the base of a modular storage box. The latch structure can include a latching element that protrudes outwards from the base. When a modular storage box is connected to another modular storage box in a vertical stacked arrangement, the latch structure on the base of the first modular storage box may be received within a groove formed in the lid of the second modular storage box. Thus, the latching structure may strengthen the connection between modular storage boxes by securing the modular storage boxes together. In some examples, the latch structure may also include a biasing element. The biasing element, which may be a spring biasing element, may bias the connection between the first modular storage box and the second modular storage box. In particular, and as mentioned above, respective insertion portions of the base may be inserted into respective receiving portions of a lid. The biasing element may apply a force (e.g., a horizontal force) to drive the respective insertion portions into the pocket formed by the receiving portions to further strengthen the connections.

In some embodiments, for added versatility in latching multiple modular storage boxes together, the smooth rail mounting system may be implemented by inverted French cleats where respective insertion portions include protrusions that protrude outwards from the respective modular storage box in opposing directions (e.g., in an upward-downward direction). Similarly, the respective receiving portions of the modular storage box may include inverted receiving portions configured to couple and/or decouple with the inverted insertion portions. The inverted French cleat rail system enables improved latching by increasing the latching surface area. Additional aspects described herein include handles affixed to the modular storage box, where the handles include through holes for ratchet strap configurations and a universal latching mechanism included in the smooth rail mounting system to accept other modular storage boxes and/or other tool kits (e.g., “ClickFit” accessories).

In another example, a modular storage system can be integrated with (e.g., coupled and/or decoupled to) a hand truck having removeable wheels. The hand truck includes a mounting plate formed from stamped steel or other rigid material. Portions of the stamped steel may be molded and/or bent outwards to form a respective receiving portion(s) configured to interface with respective insertion portions of a modular storage box having the herein described smooth rail mounting system. For instance, a back portion of a modular storage box can include respective insertion portions (e.g., continuous and/or a staggered pattern of insertions portions) that can interface with the receiving portion(s) on the mounting plate of the hand truck enabling quick coupling and/or decoupling. In additional aspects, mounting plate of the hand truck may include a latching mechanism configured to extend through the mounting plate and couple with a receiving portion defined on the back portion of the modular storage box to further strengthen the connection. In additional examples, the wheels of the hand truck system and the frame of the hand truck system may be removed from the mounting plate thereby leaving a single mounting plate. The mounting plate may then be affixed to a wall, for example in a garage or tool shop, thereby serving as another mounting location for the modular storage boxes.

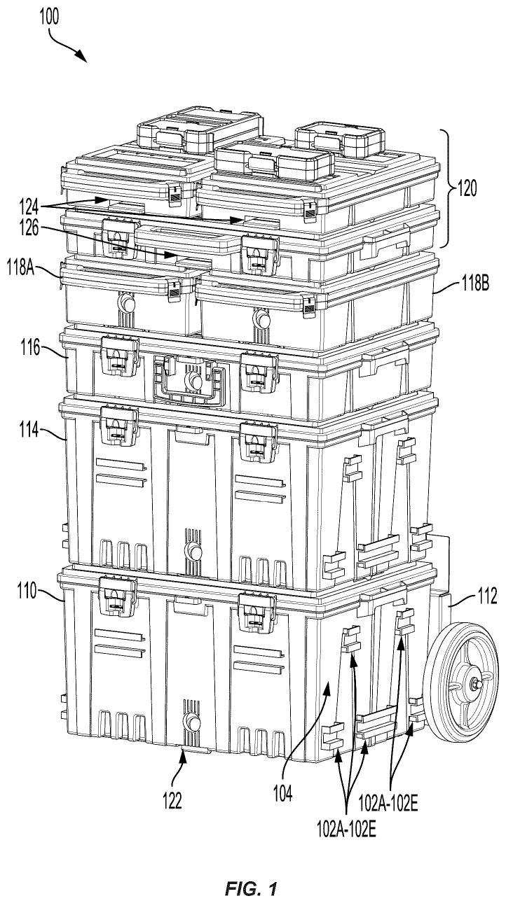

Referring now to the figures, FIG. 1 is a perspective view of a modular storage system that includes a smooth rail system according to some aspects of the present disclosure. As illustrated, storage system 100 can include multiple modular storage boxes. The storage system 100 includes a full-size modular storage box 110 mounted to a hand truck 112. The full-size modular storage box 110 includes a rail insertion system 104 including a variety of protruding hook structures 102A-102E discontinuously spaced at regular distances along the width of the sidewall of the full-size modular storage box 110. The rail insertion system 104 enables efficient and secure latching of the full-size modular storage box 110, for example, to a wall mount. Although only two faces of the full-size modular storage box 110 are visible, similar rail insertion systems including additional hook structures similar to hook structures 102A-102E may be integrated into any face (including the base and/or lid) of the full-size modular storage box 110. For instance, as shown in FIG. 1, front face of the full-size modular storage box 110 includes a similar rail insertion system. Additionally, and although not visible in the example storage system 100, additional rail insertion systems may be integrated into the back surface (e.g., the surface adjacent to the hand truck 112), the side surface opposite the visible side having hook structures 102A-102E, the lid, and or the base of the full-size modular storage box 110 to thereby enable efficient and secure latching of the full-size modular storage box 110 to a mounting plate of the hand truck 112.

Full-size modular storage box 110 also includes latch structure 122. In the example shown in FIG. 1, the latch structure 122 is incorporated into the front surface of the full-size modular storage box 110. The latch structure 122 is vertically aligned with the front face of the full-size modular storage box 110 and is configured to drop down (e.g., protrude outwards from the base). More specifically, “vertically aligned” in this context may refer to the orientation of latch structure 122 such that its principal axis extends in a direction substantially perpendicular to the plane of the base and lid of the modular storage box 110, and substantially parallel to the front face. That is, the latch structure 122 is positioned so that, when viewed from the front, the latch structure 122 extends along a vertical axis relative to the modular storage box, and its movement or actuation is in the vertical direction (i.e., up or down) with respect to the front face. Other latch structures described herein may be horizontally aligned, for example, meaning the principal axis would extend parallel to the base and lid and the movement or actuation would be in a horizontal direction with respect to the front face. In some examples, the latch structure 122 may be received by a groove formed by a lid in a respective second modular storage box (not shown) to further secure the multiple boxes together. In addition, the latch structure 122 may include a biasing element, such as a spring. In the case of latch structure 122, the biasing element may be positioned opposite the end that is received by a groove to apply a force to push (e.g., drive) the latch structure 122 into the groove.

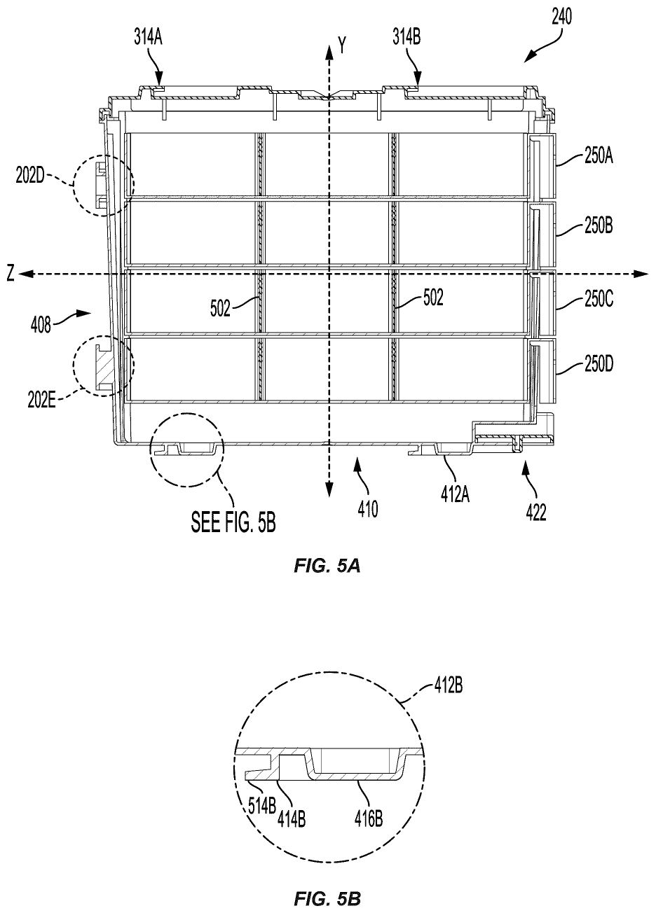

Additional latch structures are also shown in FIG. 1 that may function similarly to latch structure 122. For example, latch structures 124 and 126 are included in the various other modular storage boxes shown. However, rather than the vertical alignment as shown by latch structure 122, latch structures 124, 126 are horizontally aligned (e.g., substantially parallel) with the base of the respective modular storage box. In the case of latch structures 124, 126 and as described in more detail with respect to FIGS. 5A-5B, a protruding element may protrude out from the base surface (not shown). The protruding element may be received by a groove in a lid of another modular storage box to further strengthen the connection mechanism. Similar to latch structure 122, latch structures 124 may also include a biasing element. Additionally, latch structures may be used to horizontally connect modular storage boxes together (e.g., by bridging across a groove of two separate modular storage boxes as shown by latch structure 126 in FIG. 1.

As previously mentioned, the storage system 100 shown in FIG. 1 includes additional modular storage boxes vertically stacked together, including a second full-size modular storage box 114, a mid-sized modular storage box 116, two half width mid-sized modular storage boxes 118A and 118B, as well as additional smaller sized modular storage boxes and tool kits 120 (the plurality of modular storage boxes shown in FIG. 1 are herein referred to as the “modular storage boxes” and/or “storage boxes”). The storage boxes may be vertically stacked and coupled together using the smooth rail mounting system described herein to form a single modular storage unit. The stacked modular storage unit may be coupled to the hand truck 112 and transported from a storage location to a workspace with ease and efficiency. At the workspace, the storage boxes may quickly be decoupled from each other enabling access to the interior space to grab tools, accessories, and so on.

In addition to the vertical stacking between boxes (e.g., vertical stacking between the second full-sized modular storage box 114 and the first full-sized modular storage box 110), the described smooth rail mounting system also enables horizontal coupling as shown by the two half width mid-sized modular storage boxes 118A and 118B in FIG. 1. In more detail, each half width mid-sized modular storage boxes 118A, 118B, may latch into the lid of the mid-sized modular storage box 116 beneath it (e.g., each of the base portions of the half width mid-sized modular storage boxes 118A, 118B may include protruding cleat structures e.g., similar to protruding hook structures 102A-102E that may couple into receiving cleat structures positioned on the lid portion of the mid-sized modular storage box 116). Then, another modular storage box may span across the combined width of each half width mid-sized modular storage boxes 118A, 118B to horizontally connect them together. In some examples, a sidewall of half width mid-sized modular storage boxes 118A may also include protruding hook structures e.g., similar to protruding hook structures 102A-102E that may be coupled to receiving hook structures positioned on the respective sidewall of the half width mid-sized modular storage boxes 118B. The integrated nature of the modular storage system including a smooth rail mounting system (e.g., rail insertion system 104 and the mounting system of respective lids/bases as described more below) enables quick and secure coupling and/or decoupling between storage boxes of varying sizes as well as a high degree of configurability without reducing the interior volume of the boxes (i.e., due to the protruding and low-profile nature of the smooth rail mounting system). As such, the boxes of FIG. 1 and as described herein enable a larger interior volume having the capability of storing more tools.

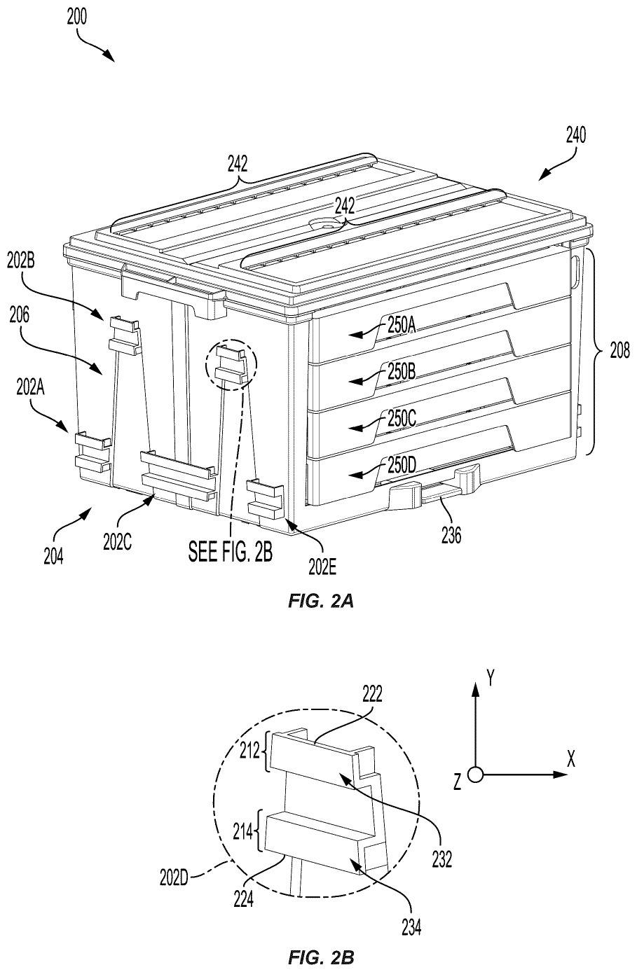

FIG. 2A is a perspective view of a modular storage box 200 that includes a smooth rail system and FIG. 2B is an enlarged view of a portion of the smooth rail system of FIG. 2A according to some aspects of the present disclosure. Specifically, FIG. 2A shows an example modular storage box 200 including a rail insertion system 204 and a mounting system 242, according to at least one example. The modular storage box 200 of FIG. 2A is similar to the full-sized modular storage box 110 of FIG. 1. For instance, modular storage box 200 includes rail insertion system 204 (e.g., similar to rail insertion system 104 of FIG. 1). As described above with respect to FIG. 1, although only one sidewall 206 of the intermediate portion 208 of modular storage box 200 is visible, similar rail insertion systems may be included on the other sidewall portions of the modular storage box 200 such as on the back portion and/or on a sidewall that is opposite to sidewall 206, and similar rail insertion systems may be included on the base and/or lid of the modular storage box 200. Rail insertion system 204 includes a plurality of hook structures 202A-202E protruding out of sidewall 206. As shown in FIG. 2A, hook structures 202A-202E may be discontinuous along sidewall 206 and spaced a regular distance apart along the width of sidewall 206. Additionally, hook structures 202A-202E may have a staggered (e.g., zig-zag) pattern on sidewall 206. For example, a staggered pattern may include hook structures on an upper row that are offset from those on a lower row, such that the hook structures in the upper row are not directly above or below the hook structures in the lower row. In other examples, the staggered arrangement may involve alternating hook structures along a diagonal across the face, or positioning the hook structures in a repeating triangular or stepped configuration. Still further, staggered may refer to arrangements where hook structures are grouped in clusters that are offset laterally or vertically from adjacent clusters, or where the spacing between hook structures varies in a non-uniform but repeating sequence.

The discontinuous and staggered pattern of hook structures 202A-202E can enable a reduction in materials when forming the modular storage box 200. Additionally, the staggered pattern enables improved strength of the latching mechanism providing for multiple coupling and/or decoupling locations. As referred to herein, the staggered pattern of hook structures refers to a plurality of hook structures positioned in different regions of a respective face (e.g., an upper region and/or a lower region and/or a side region).

Focusing specifically on hook structure 202D, hook structure 202D projects outwards from the sidewall 206 of modular storage box 200. Hook structure 202D includes a first portion 212 having a first leading end 222 oriented in a first orientation. In the example modular storage box 200 of FIG. 2A, the first leading end 222 is oriented in an upward direction (e.g., in a direction toward lid 210). Hook structure 202D also includes a second portion 214 having a second leading end 224 oriented in a second orientation. In the example modular storage box 200 of FIG. 2A, the second leading end 224 is oriented in a downward direction (e.g., opposite the first orientation in a direction toward the base portion of modular storage box 200). In addition, the first portion 212 and the second portion 214 each form a cleat insertion surface 232 and cleat insertion surface 234, respectively, oriented substantially parallel to the sidewall 206 and configured to support the modular storage box 200 when the modular storage box 200 is coupled to another modular storage box, a hand truck (e.g., hand truck 112 of FIG. 1), a wall mount, and so on. Hook structure 202D provides an example of an inverted hook structure, although the inverted hook structure is not always required. For instance, and in some examples, the hook structure 202D may only include first portion 212 or second portion 214, but not both. Focusing on the inverted hook structure, the first portion 212 oriented in the first direction provides a first hook structure and the second portion 214 oriented in the second direction provides a second hook structure that is inverted (e.g., oriented in an opposite direction) as compared to the first portion 212. The inverted hook structure shown by hook structure 202D enables stronger latching due to the increased latching surface area and/or improved flexibility in terms of mounting locations and orientations.

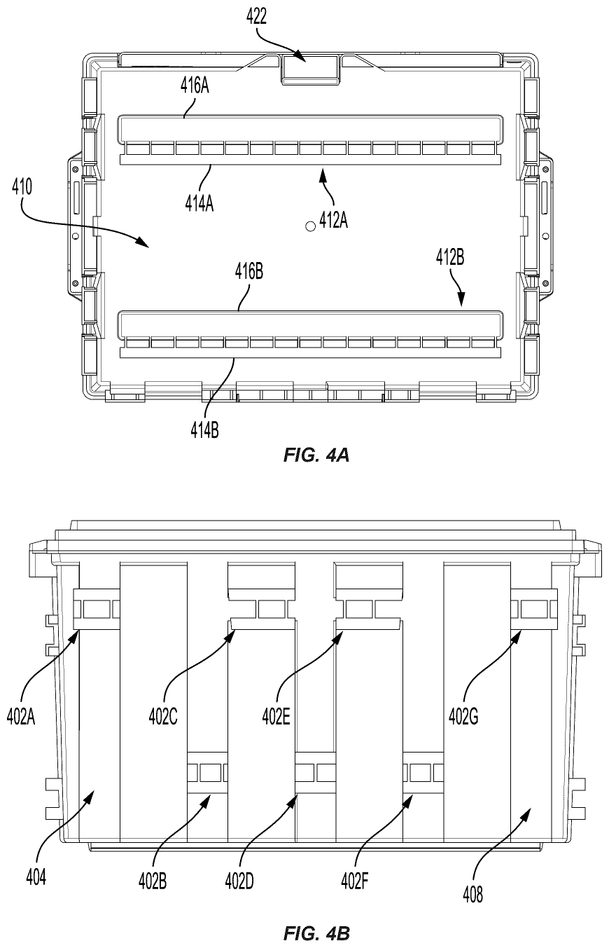

As described herein, the term “rail insertion structure” or “rail insertion system” may refer to any structure configured to protrude outwardly from a face, base, lid, or sidewall of a modular storage box, so as to engage with a corresponding rail receiving structure on another modular storage box, accessory, or mounting hardware. In the illustrated embodiments (see, e.g., FIGS. 2A, 2B, 4B), the rail insertion structures are exemplified by hook structures 202A-202E and 402A-402G, which each include a respective base portion and a leading end that defines an insertion surface for coupling with a complementary receiving surface. These hook structures may be positioned in staggered, discontinuous, or clustered patterns, and may be oriented in various directions depending on the desired mode of engagement.

Such rail insertion systems and structure are not limited to the hook-type structures shown in FIGS. 2A, 2B, 4B, however. For instance, in some examples, a rail insertion structure may comprise a dovetail projection, a tongue or rib, a T-shaped member, a stepped or ledged protrusion, a peg, or curved element. The rail insertion structure may also include a combination of shapes or profiles designed to engage with a variety of complementary receiving structures, such as channels, slots, recesses, grooves, or sockets defined on a mounting plate, wall mount, hand truck, or another modular storage box. The dimensions, cross-sectional geometry, and spacing of the rail insertion structures may be selected to provide the desired strength, retention, and ease of assembly or disassembly. Accordingly, references herein to “rail insertion structure” are intended to encompass any suitable protruding feature or set of features configured to engage a rail receiving structure, including but not limited to hooks, dovetail projections, tongues, ribs, T-members, pegs, wedges, resilient fingers, and equivalents thereof.

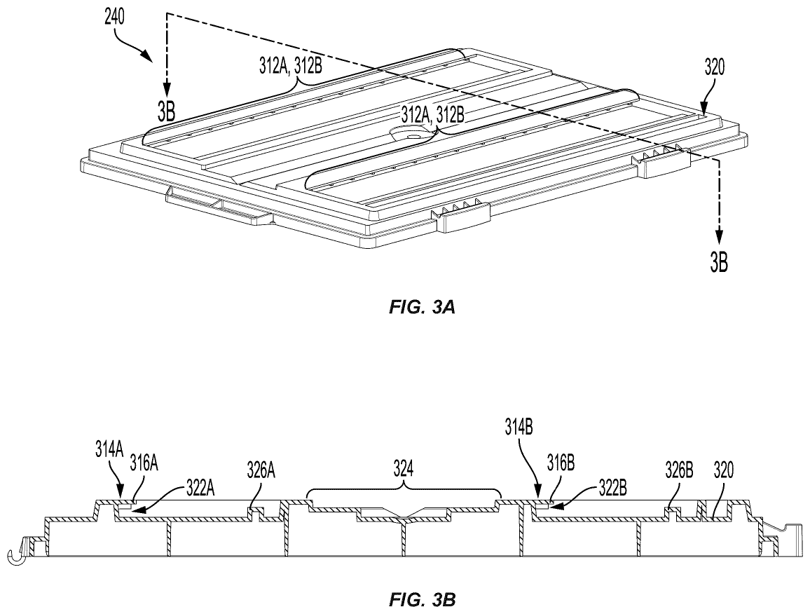

Also included on modular storage box 200 is lid 240. Lid 240 may be attached to the intermediate portion 208 via snaps, a hinge, etc. and be configured enclose the interior space of the modular storage box 200 and lift upwards to allow user access to an interior portion of the modular storage box 200. Lid 240 may include a mounting system 242 defined at the lid that includes cleat structures and engagement structures, as described in more detail with respect to FIGS. 3A and 3B. Generally, the cleat structures may define a pocket in the surface of the lid 240 where the pocket is configured to receive and couple to protruding cleat structures of another modular storage box. For example, and as described more with respect to FIG. 4A, a base portion of the modular storage box 200 (e.g., opposite the lid 240) may have protruding cleat structures (e.g., similar to hook structures 202A-202D) configured to insert into the pocket formed in the lid (e.g., leading ends of the protruding cleat structures are received by respective cleat insertion surfaces) to couple multiple modular storage boxes together. Similar mounting system as the mounting system 242 may also be defined on the sidewall portions of the modular storage box 200 (e.g., instead of the rail insertion system 204), such as sidewall 206. For example, in a modular storage system having multiple modular storage boxes, a second modular storage box may be stacked and latched into modular storage box 200 (e.g., on top of). In use, a user may want to access tools, accessories, etc. stored within modular storage box 200 but may be unable to do so because of the second modular storage box stacked on top. To enable quick access, second modular storage box may include a similar mounting system as mounting system 242 on one of its back, front, or side faces. Additionally, modular storage box 200 may have an appropriate mounting system for releasably coupling with the mounting system on the second modular storage box. In other words, a back, front or side face of modular storage box 200 may have a receiving mounting system similar to the mounting system described with respect to FIG. 4A, below. Thus, the user wanting to access modular storage box 200 can quickly detach the second modular storage box and clip it into the respective front, back or side portion of the modular storage box 200 enabling access into the inside of modular storage box 200.

Modular storage box 200 also include drawers 250A-250D. Drawers 250A-250D may slide outwards and a user may load the drawers 250A-250D with tools and/or accessories. Modular storage box 200 also includes latch structure 236. Latch structure 236 is formed in the base of modular storage box 200. As described with respect to FIG. 1, and as described in more detail with respect to FIGS. 5A-5B, latch structure 236 may include a protrusion that protrudes outwards from the base. The protrusion may be received by a groove of an engagement structure formed in a lid of a separate modular storage box when connecting multiple modular storage boxes together. In addition, the latch structure 236 may include a biasing element, such as a spring, to bias (e.g., force) the latch structure 236 into the groove. In some examples, the biasing element may include, but is not limited to, compression springs, extension springs, leaf springs, torsion springs, elastomeric members (such as rubber or silicone), foam elements, flexible polymer strips, pneumatic or hydraulic actuators, magnetic elements arranged to provide a biasing force, or any other devices or structures with biasing properties. Generally, the biasing element may be any device or structure configured to exert a force that biases the latch structure 236 into engagement with the groove. Inclusion of the a biasing element can improve the strength of the mounting system such as, for example, by applying additional force to join respective cleat structures together.

FIG. 3A is a perspective view of a lid for a modular storage box and FIG. 3B is a cross-sectional view of the lid of FIG. 3A according to some aspects of the present disclosure. Specifically, FIGS. 3A and 3B respectively show a perspective view of the lid 240 of the modular storage box 200 of FIG. 2A and a cross-section side view of the lid 240 of FIG. 3A. As shown in FIG. 3A, lid 240 includes cleat structures 312A and 312B formed on the surface of lid 240. Cleat structures 312A and 312B may be recessed into the surface of the lid 240 and configured to couple with protruding cleat structures of another modular storage box. In more detail, cleat structures 312A and 312B may be continuous and may extend for substantially the entire width of the lid. Each cleat structure 312A and 312B may include a first leading end 316A, 316B. The first leading ends 316A, 316B may form respective receiving surfaces 314A, 314B. Receiving surfaces 314A, 314B may define pockets 322A, 322B which may be configured to receive, for example, respective insertion surfaces from a second modular storage box as described above with respect to FIGS. 1 and 2. More specifically, respective insertion surfaces defined in the base of a second modular storage box may slide and/or latch under the receiving surfaces 314A, 314B to couple multiple modular storage boxes together. In some examples, receiving surfaces 314A, 314B may be parallel to the surface of the lid 240. In other examples, receiving surfaces 314A, 314B may be dovetailed (e.g., sloped at an angle) such as when the mounting system of the lid 240 is implemented with a French cleat mounting system. In these examples, the respective insertion surfaces of a second modular storage box may also be dovetailed (e.g., sloped at an angle) and configured to releasably couple with the receiving surfaces 314A, 314B.

In yet other examples, lid 240 may include further structural support to further the strengthen the latching mechanism. For instance, lid 240 can include groove 320. Groove 320 may extend longitudinally along a second portion of the lid 240 opposite pocket 322B. Groove 320 may be configured to receive a latching structure defined in a base of a second modular storage box. For example, the groove 320 may receive a latch structure similar to latch structure 122, 124, 126 described with respect to FIG. 1. In addition, and as described with respect to FIG. 1, the latch structure may include a biasing element such as a spring. The biasing element may apply a force in a direction towards pocket 322B when the latch structure is insert into the groove to further drive respective cleat structures together thereby further strengthening the connections. Although the various structures shown in FIGS. 3A and 3B, such as cleat structures 312A, 312B, pockets 322A, 322B, etc., are described as being defined on the surface of lid 240, it will be appreciated that such structures may be defined on any outer surface of a modular storage box. For example, such structures may be defined on sidewall portions of the modular storage box, such as a back sidewall portion, and such structures may be configured to releasably couple with corresponding structures defined on another modular storage box, a wall mount, tool boxes of varying sizes, a hand truck, and so on.

Examples of the present disclosure reference the term “engagement structure” which may refer to any structure or combination of structures configured to interact with a corresponding latching, cleating, or projecting feature (such as a latch structure, cleat, or insertion surface) of another modular storage box, accessory, or mounting plate, so as to provide releasable securement between the components. For example, in the implementation illustrated in FIGS. 3A and 3B, the engagement structure comprises groove 320, which is configured to receive a latch structure, such as latch structure 236, to secure two modular storage boxes together. However, the engagement structure is not limited to a groove and may take a variety of forms depending on the implementation. For instance, the engagement structure may comprise a channel, slot, recess, detent, cavity, or pocket configured to engage a corresponding protruding or movable element on another component.

In the illustrated example of FIGS. 3A-3B, the engagement structure is exemplified by groove 320 (see FIG. 3B), which receives latch structure 236 during stacking or coupling of modular storage boxes. For example, the latch structure 236 is inserted into groove 320 and a biasing element associated with the latch structure 236, such as a spring, resilient member, or other force-applying device, can exert a force against an internal surface or wall of the groove 320. This force acts in a direction that biases or pushes the modular storage boxes toward one another, thereby driving the respective cleat structures of the stacked boxes into more secure engagement. In this manner, the latch structure 236 not only retains the boxes together by its insertion into the groove 320, but also functions to enhance the strength and stability of the connection by positively pressing the cleat structures into their corresponding receiving surfaces. This arrangement reduces the likelihood of unintended separation and ensures a tight, stable fit between the coupled modular storage boxes, even under load or during transportation.

In other examples, the engagement structure may take the form of a dovetail recess (as described above with respect to dovetail 324), a T-slot, or a stepped ledge, among others. For example, a lid or sidewall may define a longitudinal dovetail groove configured to receive a complementary dovetail projection, or a base may include a channel or slot that interlocks with a tongue or rib on another accessory. The specific form and geometry of the engagement structure may be selected based on the desired direction of coupling, retention force, and ease of assembly or disassembly, and may differ from the groove illustrated in the figures. It will be appreciated that the drawings are illustrative and not limiting as to the possible forms of the engagement structure.

Lid 240 may also include dovetail 324 longitudinally extending along a center portion of the lid 240. In some examples, the dovetail 324 may extend for the entire width of the lid 240, as shown in FIG. 3A. The dovetail 324 provides additional functionality to modular storage boxes incorporating lid 240. For instance, dovetail 324 may provide additional mounting locations for tool kits or smaller modular storage boxes (as shown in FIG. 1). In addition, dovetail 324 may serve as a workspace for a user of the modular storage box incorporating lid 240. For instance, the dovetail 324 may be sized to receive, for example, a piece of lumber, piping, etc. The dovetail 324 may provide a work surface enabling a user to work on the material such as by cutting it.

FIG. 4A is a bottom view of a base portion of a modular storage box and FIG. 4B is a side view of an intermediate portion of a modular storage box according to some aspects of the present disclosure. Specifically, FIG. 4A shows a bottom view of the modular storage box 200 of FIG. 2A, according to one example. The base surface 410 of modular storage box 200 is visible in FIG. 4A. As shown in FIG. 4A, base surface 410 includes cleat structures 412A and 412B. Cleat structures 412A and 412B longitudinally extend for substantially the entire width of the modular storage box 200. Although not shown in FIG. 4A, and as described in more detail with respect to FIGS. 5A-5B, cleat structures 412A and 412B include respective cleat insertion surfaces 414A, 414B that may be received by the cleat receiving surfaces of the lid, such as cleat receiving surfaces 314A and 314B of lid 240 described with respect to FIG. 3B (e.g., cleat insertion surfaces 414A, 414B may be inserted into pockets 322A, 322B). In addition, cleat structures 412A and 412B include respective attachment portions 416A, 416B. Attachment portions 416A and 416B may abut against channels formed in the lid (e.g., channels 326A, 326B) when modular storage boxes of similar type are coupled together. More specifically, channels 326A, 326B may apply a laterally force against the cleat structures 412A, 412B to drive the respective cleat insertion surfaces 414A, 414B into the respective cleat receiving surfaces 314A and 314B. Although the cleat structures 412A and 412B are illustrated as being continuous along the base surface 410, in some examples, the cleat structures 412A and 412B may be discontinuous and/or staggered (e.g., similar to rail insertion system 204 of FIGS. 2A-2B.

Also shown in FIG. 4A, is latch structure 422. Latch structure 422 may protrude outwards from the base surface 410 and be configured to be received by a respective groove, such as groove 320, of a second modular storage box. As previously described, the latch structure 422 may include a biasing element to further strengthening the latching mechanism between multiple modular storage boxes. Similarly to as described above with respect to FIG. 3A, it will be appreciated that while the various structures of FIG. 4A, such as cleat structures 412A and 412B, are described as being defined on the base surface 410, such structures may be defined on any outer surface of a modular storage box. For example, such structures may be defined on sidewall portions of the modular storage box, such as a back sidewall portion, and such structures may be configured to releasably couple with corresponding structures defined on another modular storage box, a wall mount, a hand truck, a smaller tool kit, and so on.

According to one particular example, a first modular storage box may include a mounting system, such as the mounting system described above with respect to FIGS. 3A and 3B, having cleat structures (e.g., cleat structures similar to cleat structures 312A, 312B having respective leading ends, receiving surfaces, and pockets). The mounting system may have an opposing structure (e.g., similar to channels 326A, 326B) that is opposite to the cleat structures. The cleat structures of the mounting system may be defined on any exterior surface of the first modular storage box such as, for example, a front surface.

Continuing with the particular example, the mounting system may releasably couple with a mounting system of another modular storage box, a smaller tool kit, a wall mount, etc. For instance, a smaller tool kit may include a mounting system, such as the mounting system described with respect to FIG. 4A, having cleat structures (e.g., cleat structures similar to cleat structures 412A and 412B) and a latching structure (e.g., a latch structure similar to latch structure 422 having a spring biasing mechanism). The mounting system of the smaller tool kit may be defined on any exterior surface of the smaller tool kit such as, for example, a front surface. The mounting systems on the first modular storage box and the smaller tool kit enable the smaller tool kit to latch together (i.e., clip into) the first modular storage box. In more detail, the cleat structure(s) of the smaller tool kit may insert into the pocket(s) of the cleat structures on the first modular storage box. Then, the latching structure of the smaller tool kit mounting system may clip into the mounting system on the first modular storage and the spring biasing mechanism can drive the latching structure into, for example, the opposing structure of the first modular storage box to secure the structures together.

It will be appreciated that the herein described rail insertion/receiving structures and mounting systems (i.e., having cleat structures, grooves, channels, etc.) may be defined on any surface of a modular storage box, wall mount, hand truck, and smaller accessories (e.g., trays, tool boxes, tool kits, and so on). In addition, any combination of mounting systems and/or rail systems may be used. For instance, example modular storage boxes may include the herein described mounting systems and rail systems on one exterior surface, more than one exterior surface, all exterior surfaces, or any combination thereof. Importantly, the described rail insertion/receiving structures and mounting systems provide a high degree of flexibility and configurability for a user seeking to connect and access tools in a modular storage system.

FIG. 4B shows a back view of the modular storage box 200 of FIG. 2A, according to one example. In the back view of FIG. 4B, the back surface 408 of the modular storage box 200 is visible. As shown, back surface 408 includes rail insertion system 404 including a plurality of hook structures 402A-402G. Similar to the rail insertion system 204 described with respect to FIGS. 2A-2B, rail insertions system 404 and each respective hook structure 402A-402G may protrude outwards from back surface 408 and the hook structures 402A-402G may be discontinuous and spaced a regular distance apart on the back surface 408 to reduce material costs. Additionally, hook structures 402A-402G may have a staggered (e.g., zig-zag) pattern on back surface 408 to improve strength of the latching mechanism providing for multiple latch locations. Similar to hook structure 202D, each hook structure 402A-402E can include respective first and second portions each having first and second leading ends oriented in opposing orientations (e.g., opposing orientations in the upward-downward directions) thereby forming an inverted rail insertion system. In addition, each respective first portions and second portions form respective insertion surfaces oriented parallel to the back surface 408 and configured to support the modular storage box 200 when the modular storage box 200 is mounted to another modular storage box, a hand truck, a wall mount, and so on. In some examples, the rail insertion system 404 may be positioned on other outer surfaces of a modular storage box, such as a base portion, a lid portion, or another sidewall portion.

FIG. 5A is a cross-sectional view of a modular storage box and FIG. 5B is an enlarged view of a cleat structure of the modular storage box of FIG. 5A according to some aspects of the present disclosure. Specifically, FIG. 5A shows a cross-sectional view of the modular storage box 200 of FIG. 2A cut along the Y-Z plane, according to one example. As shown in FIGS. 5A-5B, a cross-sectional view of the lid 240, back surface 408, and base surface 410 can be seen. In particular, cleat structures 412A and 412B of the base surface 410 can be seen. As shown with respect to cleat structure 412B, cleat structure 412B includes cleat insertion surface 414B having leading end 514B. In the example shown in FIG. 5A-5B, the leading end 514B is parallel to the base surface 410 and defines the cleat insertion surface 414B that may be received by a cleat receiving portion positioned on a lid of another modular storage box (e.g., cleat receiving surfaces 314A and 314B of lid 240). In other examples, the leading end 514B defining the cleat insertion surface 414B may be dovetailed. Also shown in cleat structures 412B in FIGS. 5A-5B is attachment portion 416B. As described with respect to FIG. 4A, attachment portion 416B may abut against channels formed in the lid (e.g., channels 326A, 326B) when modular storage boxes of similar type are coupled together. Also shown in FIGS. 5A-5B is latch structure 422. As shown, latch structure 422 may protrude outwards from the base surface and be configured to be received by a respective groove, such as groove 320, of a second modular storage box.

FIG. 5A also shows a cross-sectional view of hook structures 202D and 202E as described with respect to FIGS. 2A-2B as well as cross sectional side view of drawers 250A-250D. Also included in FIG. 5A are dividers 502. Dividers 502 may divide individual drawers (e.g., drawers 250A-250D) into smaller compartments. Dividers 502 may vertically extend from the base of the drawer to the top of the drawer. Dividers 502 may improve organization of accessories and tools in the modular storage box 200 by keeping different components separated.

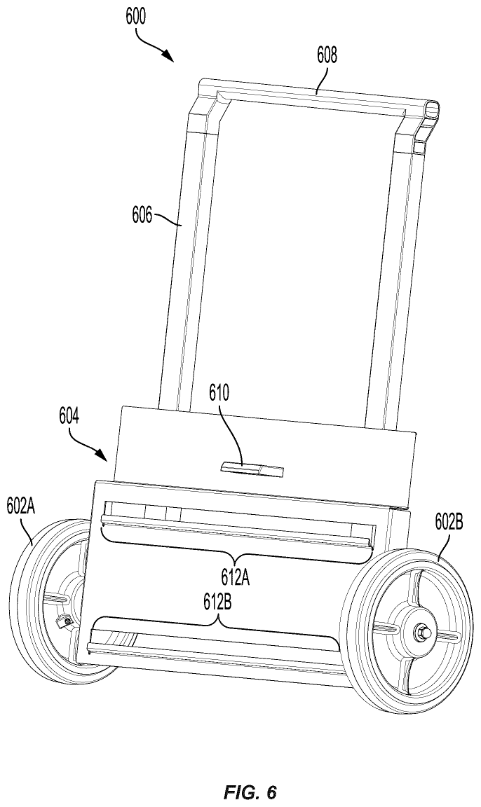

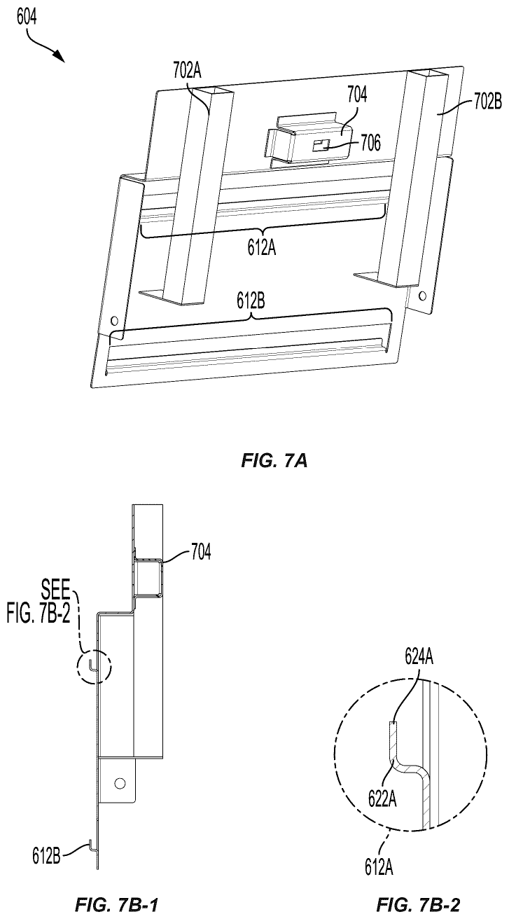

FIG. 6 is a perspective view of a hand truck with a mounting plate according to some aspects of the present disclosure. Specifically, FIG. 6 illustrates a perspective view of a hand truck 600, according to one example. Hand truck 600 includes wheels 602A, 602B, mounting plate 604, frame 606, and handle 608. The mounting plate 604 is configured to be couplable with a modular storage box incorporating the described smooth rail mounting, such as the rail insertion system 404 of FIG. 4B included on the back surface 408 of modular storage box 200. More specifically, mounting plate 604 includes hook structures 612A and 612B. As described in more detail with respect to FIG. 7A and 7B-1, 7B-2, hook structures 612A and 612B may be continuous and may extend for substantially the entire width of the mounting plate 604. Hook structure 612A and hook structure 612B can each include a leading end forming respective receiving surfaces configured to receive respective hook structures defined on a modular storage box, such as the hook structures 402A-402G each having respective insertion surfaces. In this way, a modular storage box, such as modular storage box 200 may quickly and securely latch into the hand truck 600 for transportation. Also shown in FIG. 6 is connection element 610. Connection element 610 may extend through the mounting plate 604 and couple with a receiving portion defined on the back portion of the modular storage box to further strengthen the connection. In some examples, the hook structures on the respective face of the modular storage box (e.g., hook structure 202D) may provide the suitable receiving portion.

FIG. 7A is perspective view of the mounting plate of FIG. 6, FIG. 7B-1 is a side view of the mounting plate of FIG. 7A, and FIG. 7B-2 is an enlarged view of a portion of the mounting plate of FIGS. 7A-7B according to some aspects of the present disclosure. Specifically, FIGS. 7A and 7B-1, 7B-2 respectively show a perspective view and a cross-sectional view of the mounting plate 604 of FIG. 6, according to one example. As shown in FIG. 7A, a backside of mounting plate 604 include guide rails 702A, 702B. Guide rails 702A and 702B may receive respective portions of the frame 606 and secure the respective legs of the frame 606 to the mounting plate 604. Also shown in FIG. 7A is wall attachment 704 including a through hole 706. In some examples, connection element 610 may extend through the through hole 706 and engage with the receiving portion of the modular storage box. In other examples, wall attachment 704 may be used to secure the mounting plate 604 to a wall. In some examples, rather than use the mounting plate 604 with hand truck 600, a user may mount the mounting plate 604 to the wall. In this way, a user may store modular storage boxes, such as modular storage box 200, in an organized manner on the wall (e.g., such as in a garage, tool shop, etc.). To affix the mounting plate 604 to the wall or another surface, a user may drive a bolt, screw, etc. through the through hole 706 in wall attachment 704.

FIGS. 7A and 7B-1, 7B-2 also illustrate hook structures 612A and 612B. In more detail, hook structure 612A includes leading end 624A. Leading end 624A protrudes out from the surface of the mounting plate 604 and defines hook receiving surface 622A which may be parallel to the surface of the mounting plate 604. The leading end 624A of hook structure 612A has a first orientation pointing upwards in the upward-downwards direction. It will be appreciated that the orientation and structure of hook structure 612A enables receipt of a hook insertion surface having an orientation in the opposite direction (e.g., a downward direction in the upward-downward direction). For example, a user may couple the modular storage box 200 to the mounting plate 604. In this case, a hook structure of the modular storage box 200 (e.g., one or more of hook structure 402A, 402C, 402E, or 402G) having a leading end oriented in a downward direction may couple into (e.g., abut against) the hook receiving surface 622A to coupled the modular storage box 200 to the mounting plate 604. After coupling, the modular storage box 200 may be held in place by gravity. In addition, an additional connection element, such as connection element 610, may be utilized to further strengthen the connection wherein the connection element 610 extends through the mounting plate 604 (via through hole 706) and latches to a receiving portion of the modular storage box 200.

In some examples, a storage system is provided according to the present disclosure. The storage system can include a modular storage box. The modular storage box can include a base, a lid, at least one exterior face connecting the base to the lid, and a mounting system defined at the lid. The mounting system can include a cleat structure described herein defining a pocket extending longitudinally along a first portion of the lid with an opening oriented in a first orientation and an engagement structure comprising a groove extending longitudinally along a second portion of the lid opposite the pocket. The modular storage box can also include a rail insertion system defined at the at least one exterior face. The rail insertion system can include at least one rail insertion structure protruding outwards from the at least one face and having a second opening oriented in a second orientation. In some examples, the modular storage box can also include a hand truck. The hand truck can include a frame having a first frame end including a handle and a second frame end including one or more wheels and a base plate coupled to the frame at the second frame end and having a rail receiving system configured to releasably couple with the rail insertion system of the modular storage box.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A modular storage box, comprising:
a base;
an intermediate portion having a first end and a second end, wherein the base is coupled to the intermediate portion at the first end, and wherein the intermediate portion comprises a plurality of faces;
a lid coupled to the intermediate portion at the second end, wherein the lid encloses an interior volume of the modular storage box; and
a mounting system defined at the lid, the mounting system comprising:
a cleat structure defining a pocket extending longitudinally along a first portion of the lid with an opening oriented in a first orientation; and
an engagement structure comprising a groove extending longitudinally along a second portion of the lid opposite the pocket.

2. The modular storage box of claim 1, wherein the cleat structure is releasably couplable with a corresponding cleat structure positioned on a second base of a second modular storage box.

3. The modular storage box of claim 1, wherein the cleat structure comprises a base portion including a base leading end defining a cleat insertion surface.

4. The modular storage box of claim 3, wherein the pocket is formed in a space between the cleat insertion surface and a surface of the lid.

5. The modular storage box of claim 3, wherein the cleat insertion surface is substantially parallel to a planar surface of the lid.

6. The modular storage box of claim 1, wherein the base comprises a latch structure having a principal axis that extends perpendicular to a planar surface of the lid and is positioned such that the latch structure is receivable by a corresponding groove of a second modular storage box.

7. The modular storage box of claim 6, wherein the latch structure comprises a biasing element configured to apply a horizontal force in a direction of the first orientation when the latch structure is received by the corresponding groove of the second modular storage box.

8. The modular storage box of claim 7, wherein the biasing element comprises a spring.

9. The modular storage box of claim 1, wherein the base comprises at least one cleat insertion structure having a base portion and a base leading end, wherein the base leading end is configured to be inserted into a pocket of a second modular storage box to latch the modular storage box to the second modular storage box.

10. A modular storage box, comprising:
a base;
an intermediate portion having a first end and a second end, wherein the base is coupled to the intermediate portion at the first end, and wherein the intermediate portion comprises a plurality of faces;
a lid coupled to the intermediate portion at the second end, wherein the lid encloses an interior volume of the modular storage box; and
a rail system defined on at least one face of the plurality of faces, the rail system comprising:
a plurality of rail insertion structures protruding outwards from the at least one face, wherein each rail insertion structure includes a respective base and a respective leading end thereby forming a respective rail insertion surface.

11. The modular storage box of claim 10, wherein each rail insertion structure is oriented in a direction extending towards the base.

12. The modular storage box of claim 10, wherein the at least one face comprises a first upper region and a first lower region, wherein a first subset of the plurality of rail insertion structures are positioned in the first upper region and a second subset of the plurality of rail insertion structures are positioned in the first lower region.

13. The modular storage box of claim 12, wherein the first subset of the plurality of rail insertion structures and the second subset of the plurality of rail insertion structures are discontinuous along the at least one face.

14. The modular storage box of claim 12, wherein the first subset of the plurality of rail insertion structures are staggered with respect to the second subset of the plurality of rail insertion structures thereby defining a staggered pattern on the at least on face.

15. The modular storage box of claim 10, wherein the plurality of rail insertion structures are configured to releasably couple with corresponding rail receiving structures outwardly protruding from a mounting plate secured to a wall.

16. The modular storage box of claim 15, wherein the rail receiving structures are oriented in a direction opposite the second orientation.

17. The modular storage box of claim 1, wherein the plurality of faces comprises a first side face including a first handle and a second side face including a second handle.

18. The modular storage box of claim 17, wherein the first handle and the second handle each include a through hole.

19. A storage system, comprising:
a first modular storage box comprising:
a base;
an intermediate portion having a first end and a second end, wherein the base is coupled to the intermediate portion at the first end, and wherein the intermediate portion comprises a plurality of faces;
a lid coupled to the intermediate portion at the second end, wherein the lid encloses an interior volume of the first modular storage box; and
a first mounting system defined at the base, the first mounting system comprising a first base leading end orthogonally extending from a cleat insertion surface, wherein the first base leading end is parallel to the base;
a second modular storage box comprising:
a lid having a second mounting system, wherein the second mounting system comprises:
a cleat structure defining a pocket extending longitudinally along a first portion of the lid with an opening oriented in a first orientation; and
an engagement structure comprising a groove extending longitudinally along a second portion of the lid opposite the pocket,
wherein the second mounting system is configured to receive the first base leading end of the first mounting system in the pocket to releasably couple the first modular storage box to the second modular storage box thereby defining a combined modular storage box.

20. The storage system of claim 19, further comprising
a hand truck, comprising:
a frame having a first frame end including a handle and a second frame end including one or more removable wheels; and
a base plate coupled to the frame at the second frame end and having a rail receiving system configured to releasably couple with a rail insertion system of one of the first modular storage box or the second modular storage box.
